(19) United States
(12) Patent Application Publication
(10) Pub. No.: US 2006/0263529 A1
(43) Pub. Date: Nov. 23, 2006

(54) Paint system and method of painting fiber reinforced polypropylene composite components

(76) Inventors: Arnold Lustiger, Edison, NJ (US); Jeffrey Valentage, Royal Oak, MI (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/435,579

(22) Filed: May 17, 2006

Related U.S. Application Data
(63) Continuation-in-part of application No. 11/395,493, filed on Mar. 31, 2006.
Application No. 11/395,493 is a continuation-in-part of application No. 11/387,496, filed on Mar. 23, 2006.
Application No. 11/387,496 is a continuation-in-part of application No. 11/318,363, filed on Dec. 23, 2005.
Application No. 11/318,363 is a continuation-in-part of application No. 11/301,533, filed on Dec. 13, 2005.
(60) Provisional application No. 60/681,609, filed on May 17, 2005.

(51) Int. Cl. B05D 3/12

(52) U.S. Cl. 427/322

(57) ABSTRACT

A method of painting a fiber reinforced composite vehicle component, the fiber reinforced composite vehicle component molded from a composition comprising a polypropylene based resin, an organic fiber and an inorganic filler, the component having at least a first surface. The method includes the steps of lowering the surface tension of the first surface of the fiber reinforced composite vehicle component, applying a base coat paint to the first surface of the fiber reinforced composite vehicle component and applying a clear coat paint to the first surface of the fiber reinforced composite vehicle component. A paint system and a process for producing a painted fiber reinforced polypropylene composite vehicle component are also provided.

### CROSS-REFERENCE TO RELATED APPLICATIONS

This application is a Continuation-in-Part of U.S. patent application Ser. No. 11/395,493 filed Mar. 31, 2006, which is a Continuation-in-Part of U.S. patent application Ser. No. 11/387,496, filed Mar. 23, 2006, which is a Continuation-in-Part of U.S. patent application Ser. No. 11/318,363, filed Dec. 23, 2005, which is a Continuation-in-Part of U.S. patent application Ser. No. 11/301,533, filed Dec. 13, 2005, and claims priority of U.S. Provisional Application Ser. No. 60/681,609, filed May 17, 2005, the contents of each are hereby incorporated by reference.

### FIELD OF THE INVENTION

The present invention is directed generally to painting vehicle body panels and other components produced from fiber reinforced polypropylene compositions and to a paint system and method therefore.

### BACKGROUND OF THE INVENTION

In the molding of automobile parts, such as body panels and the like, injection molding, thermoforming and structural molded compound (SMC) processes have been employed using a variety of materials. Attempts are underway in the automotive industry to produce an ever increasing number of molded plastic parts. As is widely appreciated, plastic parts have the advantage of light weight, corrosion resistance and lower cost.

The automotive industry generally requires that all surfaces visible to the consumer exhibit a “class A” surface quality. At a minimum, such surfaces must be smooth, glossy, and weatherable. The steps required to prepare such a surface may be expensive and time consuming and may affect mechanical properties.

Polyolefins have seen limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address the toughness issue. For example, it is known to increase the toughness of polypropylene by adding rubber particles, either in-reactor resulting in impact copolymers, or through post-reactor blending. However, while toughness is improved, stiffness is considerably reduced using this approach.

Injection molding of thermoplastic resin has been used for many small articles. While some larger articles have been made, the parts have not served structural purposes. For example, fenders and doors have been made by injection molding. As may be appreciated, fenders and doors are not load-bearing, have little structural integrity and must be attached to the frame of the car body. Further, the outer surfaces must be painted or be molded in conjunction with a polymeric skin layer, since surface flaws are inherent.

Resin transfer molding (RTM) has been used to make certain external body parts. In this process, a glass or graphite pre-form is positioned in a mold and a liquid thermosetting resin is injected into the mold. The thermosetting resin solidifies and forms the body of the part. Such parts typically require structural support and have a relatively poor surface finish. Parts produced by RTM have traditionally been painted, since the surface finish has not otherwise been satisfactory.

Thermosetting polyester filled with chopped fibers has been compression molded into relatively large sheets or panels. Despite many attempts to produce panels having a high quality surface finish, the surface finish obtained is not particularly good.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding.

Thermoplastic resins employing glass fibers have been extruded in sheet form. Glass fibers have also been used as a laminate in thermoplastic resin sheet form. The sheets can then be compression molded to a particular shape. As may be appreciated by those skilled in the art, compression molding has certain limitations since compression molded parts cannot be deeply drawn and thus must possess a relatively shallow configuration. Additionally, such parts are not particularly strong and require structural reinforcements when used in the production of vehicle body panels. Moreover, the surface finish of glass-filled resins is generally poor. Components made of glass-filled compositions often require extensive surface preparation and the application of a curable coating to provide a surface of acceptable quality and appearance.

Although the as-molded surface quality of glass-filled components continues to improve, imperfections in their surfaces due to exposed glass fibers, glass fiber read-through, and the like often occur. These surface imperfections may further result in imperfections in coatings applied to such surfaces. Defects in the surface of glass-filled compositions and in-cured coatings applied to the surfaces of glass-filled compositions may manifest as paint popping, high long- and short-term wave scan values, orange peel, variations in gloss or the like.

Several techniques have been proposed to provide surfaces of acceptable appearance and quality. For example, overmolding of thin, preformed paint films has been employed to produce required Class A surfaces. However, such overmolding is usually applicable only for those compositions capable of providing virgin molded surfaces that do not require any secondary surface preparation operations. Although as-molded surface quality has improved, as-molded surfaces of component parts continue to require sanding, especially at the edges, followed by sealing and priming prior to painting. In-mold coating can obviate these operations, but only at the cost of greatly increased cycle time and cost. Such processes use expensive paint systems that may be applied to the part surface while the mold is re-opened slightly, and then closed to distribute and cure the coating.

As an alternative to the use of glass fibers, another known method of improving the properties of polyolefins is organic fiber reinforcement. For example, EP Patent Application No. 0397881, the entire disclosure of which is hereby incorporated herein by reference, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, discloses a composition including a polymer, such as polypropylene, and uniformly dispersed therein at least about 10% by weight of the composition staple length fiber, the fiber being of man-made polymers, such as poly(ethylene terephthalate) (PET) or poly(1,4-cyclohexylenedimethylene terephthalate).

Fiber reinforced polypropylene compositions are also disclosed in PCT Publication WO 02/053629, the entire disclosure of which is hereby incorporated herein by reference. More specifically, WO 02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO90/05164; EP Patent Application 0669372; U.S. Pat. No. 6,395,342 to Kadowaki et al.; EP Patent Application 1075918; U.S. Pat. No. 5,145,891 to Yasukawa et al., U.S. Pat. No. 5,145,892 to Yasukawa et al.; and EP Patent 0232522, the entire disclosures of which are hereby incorporated herein by reference.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Application Ser. No. 11/318,363, filed Dec. 13, 2005, notes that consistently feeding PET fibers into a compounding extruder is a problem encountered during the production of polypropylene (PP)-PET fiber composites. Conventional gravimetric or vibrational feeders used in the metering and conveying of polymers, fillers and additives into the extrusion compounding process, while effective in conveying pellets or powder, are not effective in conveying cut fiber. Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configuration may impact the dispersion of PET fibers within the PP matrix, and extrusion compounding processing conditions may impact not only the mechanical properties of the matrix polymer, but also the mechanical properties of the PET fibers. Application Ser. No. 11/318,363, filed Dec. 13, 2005, proposes solutions to these problems.

Another problem associated with the use of polyolefins and other thermoplastic materials in the production of vehicle components, such as body panels, interior trim panels and other interior trim pieces, is the difficulty normally associated with providing a painted surface having excellent adhesion and weatherability characteristics. While, as noted above, several techniques have been proposed to provide surfaces of acceptable appearance and quality, including the overmolding of thin, preformed paint films to produce Class A surfaces, such techniques have limited applicability for a variety of reasons. Although in-mold coating can be employed, penalties with respect to increased cycle time and cost exist, as these processes use expensive paint systems that must be applied to the part surface while the mold is re-opened slightly, and then closed to distribute and cure the coating. Moreover, conventional solvent-based adhesion promoters have not proven to be universally acceptable when used with the more conventional automotive paint systems.

Despite these advance in the art, a need still exists for a paint system and method of painting composite vehicle components, including body panels, interior panels, trim pieces and the like, having improved surface finish, adhesion and weatherability characteristics and for a process for making painted fiber reinforced polypropylene composite vehicle components.

### SUMMARY OF THE INVENTION

Provided is a method of painting a fiber reinforced composite vehicle component, the fiber reinforced composite vehicle component molded from a composition comprising a polypropylene based resin, an organic fiber and an inorganic filler, the component having at least a first surface. The method includes the steps of lowering the surface tension of the first surface of the fiber reinforced composite vehicle component, applying a base coat paint to the first surface of the fiber reinforced composite vehicle component and applying a clear coat paint to the first surface of the fiber reinforced composite vehicle component.

In another aspect, provided is a paint system for use in painting a fiber reinforced composite vehicle component molded from a composition comprising a polypropylene based resin, an organic fiber and an inorganic filler, the component having at least a first surface of reduced surface tension. The paint system includes a base coat paint for applying to the first surface of the fiber reinforced composite vehicle component and a clear coat paint for applying over the base coat, wherein the paint system exhibits excellent adhesion characteristics in the absence of a solvent-based adhesion promoter.

In yet another aspect, provided is a process for producing a painted fiber reinforced polypropylene composite vehicle component. The process includes the steps of feeding into a twin screw extruder hopper at least about 25 wt. % of a polypropylene based resin with a melt flow rate of from about 20 to about 1500 g/10 minutes, continuously feeding by unwinding from one or more spools into the twin screw extruder hopper from about 5 wt % to about 40 wt % of an organic fiber, feeding into a twin screw extruder from about 10 wt % to about 60 wt % of an inorganic filler, extruding the polypropylene based resin, the organic fiber, and the inorganic filler through the twin screw extruder to form a fiber reinforced polypropylene composite melt, cooling the fiber reinforced polypropylene composite melt to form a solid fiber reinforced polypropylene composite, molding the fiber reinforced polypropylene composite to form the vehicle component, the vehicle component having at least a first surface, lowering the surface tension of the first surface of the fiber reinforced composite vehicle component, applying a base coat paint to the first surface of the fiber reinforced composite vehicle component and applying a clear coat paint to the first surface of the fiber reinforced composite vehicle component.

Numerous advantages result from the paint systems and methods of painting composite vehicle components and the method of making disclosed herein and the uses/applications therefore.

For example, in exemplary embodiments of the present disclosure, the painted polypropylene fiber composite vehicle components exhibit improved paint adherence, without the need for adhesion promoters.

In a further exemplary embodiment of the present disclosure, the painted polypropylene fiber composite vehicle components exhibit improved fuel resistance.

In a further exemplary embodiment of the present disclosure, the painted polypropylene fiber composite vehicle components exhibit improved scuff resistance.

In yet a further exemplary embodiment of the present disclosure, the painted polypropylene fiber composite vehicle components exhibit improved water resistance.

In yet a further exemplary embodiment of the present disclosure, the painted polypropylene fiber composite vehicle components exhibit improved chip resistance.

In still yet a further exemplary embodiment of the present disclosure, the disclosed painted polypropylene fiber composite vehicle components exhibit class A surface finishes.

In still yet a further exemplary embodiment of the present disclosure, the disclosed polypropylene fiber composite vehicle body panels exhibit the requisite characteristics necessary for use as a hood, a roof, a deck lid, a door, a front or rear fender, a rocker panel, a fascia, a fender liner, a firewall, a truck bed, a tailgate, a radiator support, an airdam, a rollpan, a support bracket, a cowl screen, a lift gate, a step assist, a running board, a rub strip, cladding and a front or a rear quarter panel.

These and other advantages, features and attributes of the disclosed paint systems and methods of painting polypropylene fiber composite components, and method of making of the present disclosure and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 is a frontal perspective view showing fiber reinforced polypropylene composite body panels used to form the body of an automobile;

FIG. 2 is a rear perspective view showing fiber reinforced polypropylene composite body panels used to form the body of an automobile;

FIG. 3 is a top plan view of a fiber reinforced polypropylene composite automobile hood;

FIG. 4 is a cross-sectional view of the FIG. 3 fiber reinforced polypropylene composite automobile hood taken along line 4-4;

FIG. 5 depicts an exemplary schematic of the process for making fiber reinforced polypropylene composites of the instant invention;

FIG. 6 depicts an exemplary schematic of a twin screw extruder with a downstream feed port for making fiber reinforced polypropylene composites of the instant invention;

FIG. 7 depicts an exemplary schematic of a twin screw extruder screw configuration for making fiber reinforced polypropylene composites of the instant invention; and

FIG. 8 is an exemplary overhead schematic view of a manufacturing line for producing painted fiber reinforced polypropylene composites, in accordance with one embodiment of the instant invention.

### DETAILED DESCRIPTION OF THE INVENTION

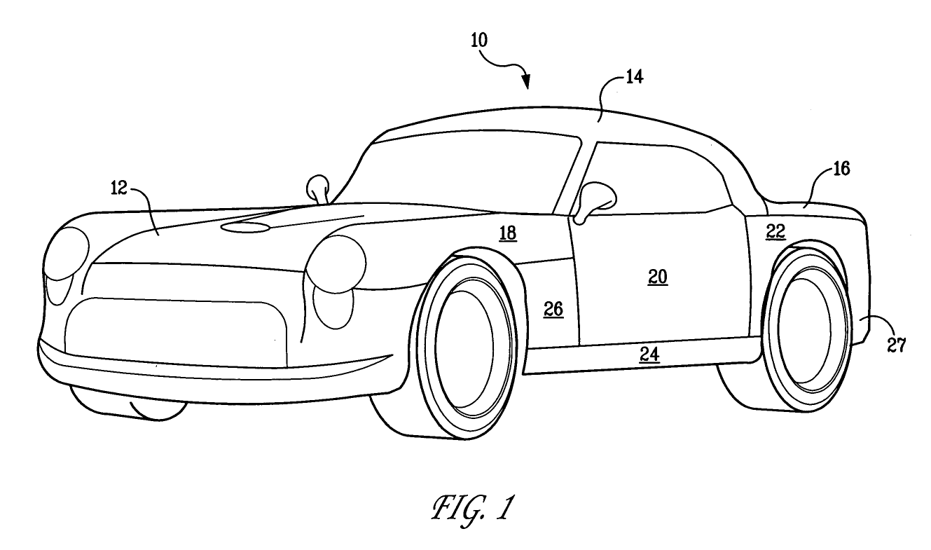

Reference is now made to FIGS. 1-8, wherein like numerals are used to designate like parts throughout.

Disclosed herein are improved paint systems for use with fiber reinforced polypropylene composite automotive components, such as vehicle body panels, interior trim panels and pieces, and the like, and to methods of painting such fiber reinforced polypropylene composite components.

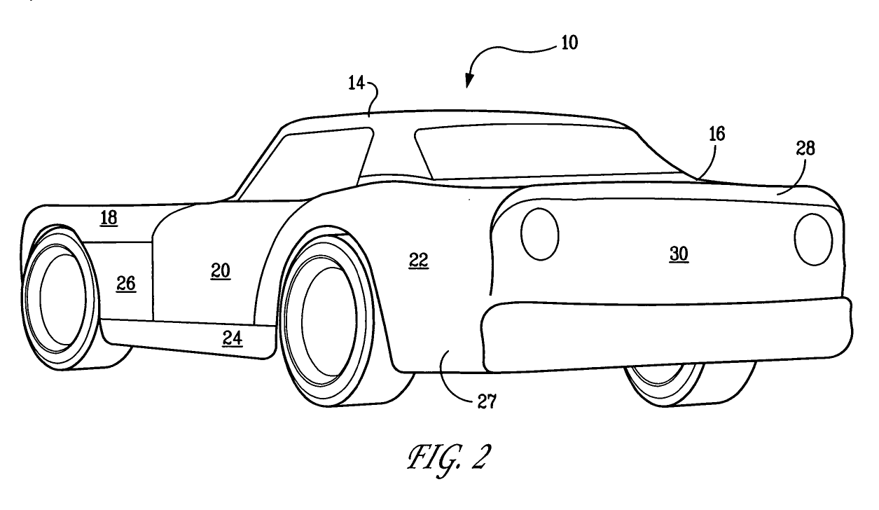

Composite automotive components of the type capable of benefiting from the paint systems and methods disclosed herein are generically depicted in FIGS. 1-4 for a vehicle 10. Referring to FIGS. 1-2, exemplary body panels include a three-dimensionally contoured hood 12, front fenders 18, outer door panels 20, rear fenders 22, deck lid panel 16, rocker panels 24, spoiler 26, front quarter panels 26, rear quarter panels 27, rear panel 30 and roof 14. As may be appreciated by those skilled in the art, other panels may also be formed, such as, interior trim panels, fuel filler doors, and exterior and interior garnish moldings.

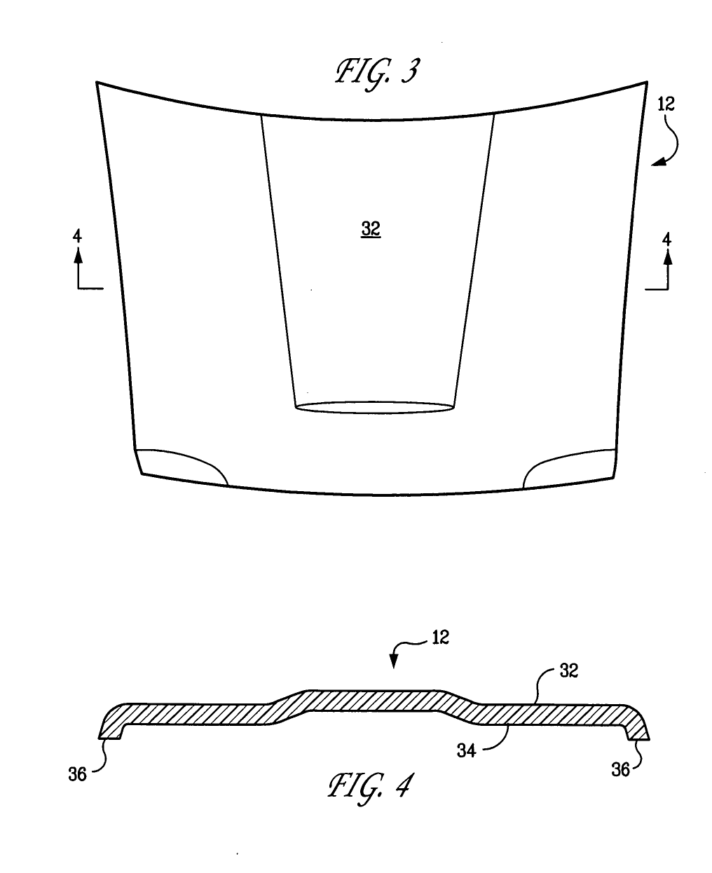

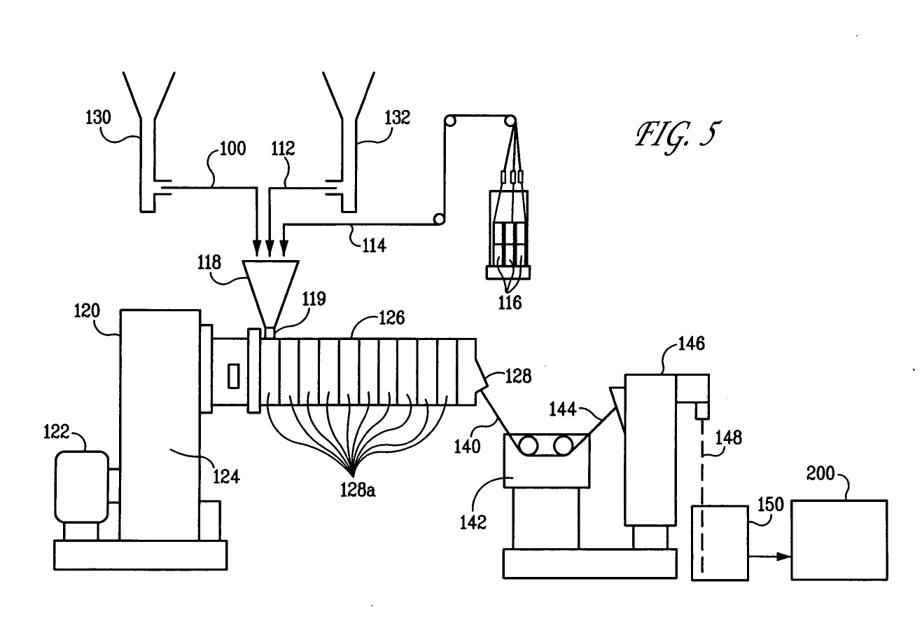

Referring to FIGS. 3-4, hood 12 has an outer surface 32 and an underside surface 34, each of which terminates at peripheral edges 36. Peripheral edges 36 may be downwardly turned as shown, cut along generally vertical planes or provided with a partial radius. Advantageously, outside surface 32 of hood 12 is provided with a class A exterior surface exhibiting extremely high finish quality characteristics, free of aesthetic blemishes and defects, eliminating the need for priming prior to the application of a base coat. As may be appreciated and will be explained in more detail below, the other exemplary body panels described herein may also be provided with a class A exterior surfaces.

The composite automotive components of the type capable of benefiting from the paint systems and methods disclosed herein are molded from a composition comprising a combination of a polypropylene based matrix with organic fiber and inorganic filler, which in combination advantageously yield body panels with a flexural modulus of at least 300,000 psi and ductility during instrumented impact testing (15 mph, −29° C., 25 lbs). The fiber reinforced polypropylene body panels employ a polypropylene based matrix polymer with an advantageous high melt flow rate without sacrificing impact resistance. In addition, the fiber reinforced polypropylene composite vehicle body panels disclosed herein do not splinter during instrumented impact testing.

The fiber reinforced polypropylene composite automotive components of the type capable of benefiting from the paint systems and methods disclosed herein simultaneously have desirable stiffness, as evidenced by possessing a flexural modulus of at least 300,000 psi, and toughness, as evidenced by possessing ductility during instrumented impact testing. The fiber reinforced polypropylene composite vehicle body panels have a flexural modulus of at least 350,000 psi, or at least 370,000 psi, or at least 390,000 psi, or at least 400,000 psi, or at least 450,000 psi. Still more particularly, the fiber reinforced polypropylene composite vehicle body panels have a flexural modulus of at least 600,000 psi, or at least 800,000 psi. It is also believed that having a weak interface between the polypropylene matrix and the fiber of the fiber reinforced polypropylene composite vehicle body panels contributes to fiber pullout; and, therefore, may enhance toughness. Thus, there is no need to add modified polypropylenes to enhance bonding between the fiber and the polypropylene matrix, although the use of modified polypropylene may be advantageous to enhance the bonding between a filler, such as talc or wollastonite and the matrix. In addition, in one embodiment, there is no need to add lubricant to weaken the interface between the polypropylene and the fiber to further enhance fiber pullout. Some embodiments also display no splintering during instrumented dart impact testing, which yield a further advantage of not subjecting a person in close proximity to the impact to potentially harmful splintered fragments.

The composite automotive components of the type capable of benefiting from the paint systems and methods disclosed herein are formed from a composition that includes at least 30 wt %, based on the total weight of the composition, of polypropylene as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another embodiment, the polypropylene is present in an amount of at least 25 wt %.

The polypropylene used as the matrix resin for use in the fiber reinforced polypropylene composite automotive components of the type capable of benefiting from the paint systems and methods disclosed herein is not particularly restricted and is generally selected from the group consisting of propylene homopolymers, propylene-ethylene random copolymers, propylene-α-olefin random copolymers, propylene block copolymers, propylene impact copolymers, and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from about 20 to about 1500 g/10 min. In a particular embodiment, the melt flow rate of the polypropylene matrix resin is greater 100 g/10 min, and still more particularly greater than or equal to 400 g/10 min. In yet another embodiment, the melt flow rate of the polypropylene matrix resin is about 1500 g/10 min. The higher melt flow rate permits for improvements in processability, throughput rates, and higher loading levels of organic fiber and inorganic filler without negatively impacting flexural modulus and impact resistance.

In a particular embodiment, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from about 0.1 wt % to less than about 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.1 wt %, or 0.5 wt %, or 2.5 wt %, to 7.5 wt %, or 10 wt %, based on the total weight of the matrix. Diffusion of additive(s) during processing may cause a portion of the additive(s) to be present in the fiber.

The invention is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the invention is not limited to any particular catalyst for making the polypropylene, and may, for example, include Ziegler-Natta or metallocene catalysts.

The composite automotive components of the type capable of benefiting from the paint systems and methods disclosed herein are formed from compositions that also generally include at least 10 wt %, based on the total weight of the composition, of an organic fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another embodiment, the organic fiber is present in an amount of at least 5 wt % and up to 40 wt %.

The polymer used as the fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another particular embodiment, the organic fiber comprises PET.

In one embodiment, the fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the fiber employed in the fiber reinforced polypropylene composite vehicle body panels contemplated herein are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the fibers is within the range having a lower limit of 10 μm and an upper limit of 100 μm.

The fiber may further contain additives commonly known in the art, such as dispersants, lubricants, flame-retardants, antioxidants, antistatic agents, light stabilizers, ultraviolet light absorbers, carbon black, nucleating agents, plasticizers, and coloring agents, such as dye or pigment.

The fiber used in the fiber reinforced polypropylene composite vehicle body panels contemplated herein is not limited by any particular fiber form. For example, the fiber can be in the form of continuous filament yarn, partially oriented yarn, or staple fiber. In another embodiment, the fiber may be a continuous multifilament fiber or a continuous monofilament fiber.

The compositions employed in the fiber reinforced polypropylene composite automotive components of the type capable of benefiting from the paint systems and methods disclosed herein optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, based on the total weight of the composition. In yet another embodiment, the inorganic filler may be included in the polypropylene fiber composite in the range of from 10 wt % to about 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, magnesium oxysulfate, titanium oxide, zinc oxide, zinc sulfate, and combinations thereof. The talc may have a size of from about 1 to about 100 microns.

Preferred for use in the compositions employed in the fiber reinforced polypropylene composite automotive components of the type capable of benefiting from the paint systems and methods disclosed herein is high aspect ratio talc. Although aspect ratio can be calculated by dividing the average particle diameter of the talc by the average thickness using a conventional microscopic method, this is a difficult and tedious technique. A particularly useful indication of aspect ratio is known in the art as “lamellarity index,” which is a ratio of particle size measurements. Therefore, as used herein, by “high aspect ratio” talc is meant talc having an average lamellarity index greater than or equal to about 4 or greater than or equal to about 5. A talc having utility in the compositions disclosed herein has a specific surface area of at least 14 square meters/gram.

In one particular embodiment, at a high talc loading of up to about 60 wt %, the polypropylene fiber composite exhibited a flexural modulus of at least about 750,000 psi and no splintering during instrumented impact testing (15 mph, −29° C. and 25 lbs). In another particular embodiment, at low talc loading of as low as 10 wt %, the polypropylene fiber composite exhibited a flexural modulus of at least about 325,000 psi and no splintering during instrumented impact testing (15 mph, −29° C. and 25 lbs). In addition, wollastonite loadings of from 5 wt % to 60 wt % in the polypropylene fiber composite yielded an outstanding combination of impact resistance and stiffness.

In another particular embodiment, a fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of greater than 100 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively

The composite automotive components of the type capable of benefiting from the paint systems and methods disclosed herein are made by forming the fiber-reinforced polypropylene composition and then injection molding the composition to form the vehicle body panel. The invention is not limited by any particular method for forming the compositions. For example, the compositions can be formed by contacting polypropylene, organic fiber, and optional inorganic filler in any of the well known processes of pultrusion or extrusion compounding. In a particular embodiment, the compositions are formed in an extrusion compounding process. In a particular aspect of this embodiment, the organic fibers are cut prior to being placed in the extruder hopper. In another particular aspect of this embodiment, the organic fibers are fed directly from one or more spools into the extruder hopper.

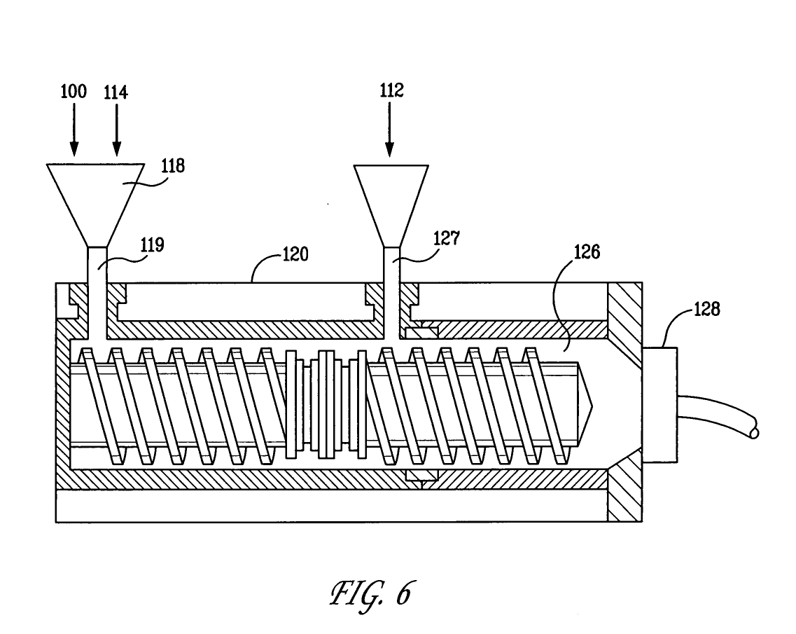

Referring now to FIG. 5 an exemplary schematic of the process for making fiber reinforced polypropylene composites of the type capable of benefiting from the paint systems and methods disclosed herein is shown. Polypropylene based resin 100, inorganic filler 112, and organic fiber 114 continuously unwound from one or more spools 116 are fed into the extruder hopper 118 of a twin screw compounding extruder 120. The extruder hopper 118 is positioned above the feed throat 119 of the twin screw compounding extruder 120. The extruder hopper 118 may alternatively be provided with an auger (not shown) for mixing the polypropylene based resin 100 and the inorganic filler 112 prior to entering the feed throat 19 of the twin screw compounding extruder 120. In an alternative embodiment, as depicted in FIG. 6, the inorganic filler 112 may be fed to the twin screw compounding extruder 120 at a downstream feed port 127 in the extruder barrel 126 positioned downstream of the extruder hopper 118 while the polypropylene based resin 100 and the organic fiber 114 are still metered into the extruder hopper 118.

Referring again to FIG. 5, the polypropylene based resin 100 is metered to the extruder hopper 118 via a feed system 130 for accurately controlling the feed rate. Similarly, the inorganic filler 112 is metered to the extruder hopper 118 via a feed system 132 for accurately controlling the feed rate. The feed systems 130, 132 may be, but are not limited to, gravimetric feed system or volumetric feed systems. Gravimetric feed systems are particularly preferred for accurately controlling the weight percentage of polypropylene based resin 100 and inorganic filler 112 being fed to the extruder hopper 118. The feed rate of organic fiber 114 to the extruder hopper 118 is controlled by a combination of the extruder screw speed, number of fiber filaments and the thickness of each filament in a given fiber spool, and the number of fiber spools 116 being unwound simultaneously to the extruder hopper 118. The higher the extruder screw speed measured in revolutions per minute (rpms), the greater will be the rate at which organic fiber 114 is fed to the twin screw compounding screw 120. The rate at which organic fiber 114 is fed to the extruder hopper also increases with the greater the number of filaments within the organic fiber 114 being unwound from a single fiber spool 116, the greater filament thickness, the greater the number fiber spools 116 being unwound simultaneously, and the rotations per minute of the extruder.

The twin screw compounding extruder 120 includes a drive motor 122, a gear box 124, an extruder barrel 126 for holding two screws (not shown), and a strand die 128. The extruder barrel 126 is segmented into a number of heated temperature controlled zones 128. As depicted in FIG. 5, the extruder barrel 126 includes a total of ten temperature control zones 128. The two screws within the extruder barrel 126 of the twin screw compounding extruder 120 may be intermeshing or non-intermeshing, and may rotate in the same direction (co-rotating) or rotate in opposite directions (counter-rotating). From a processing perspective, the melt temperature must be maintained above that of the polypropylene based resin 100, and far below the melting temperature of the organic fiber 114, such that the mechanical properties imparted by the organic fiber will be maintained when mixed into the polypropylene based resin 100. In one exemplary embodiment, the barrel temperature of the extruder zones did not exceed 154° C. when extruding PP homopolymer and PET fiber, which yielded a melt temperature above the melting point of the PP homopolymer, but far below the melting point of the PET fiber. In another exemplary embodiment, the barrel temperatures of the extruder zones are set at 185° C. or lower.

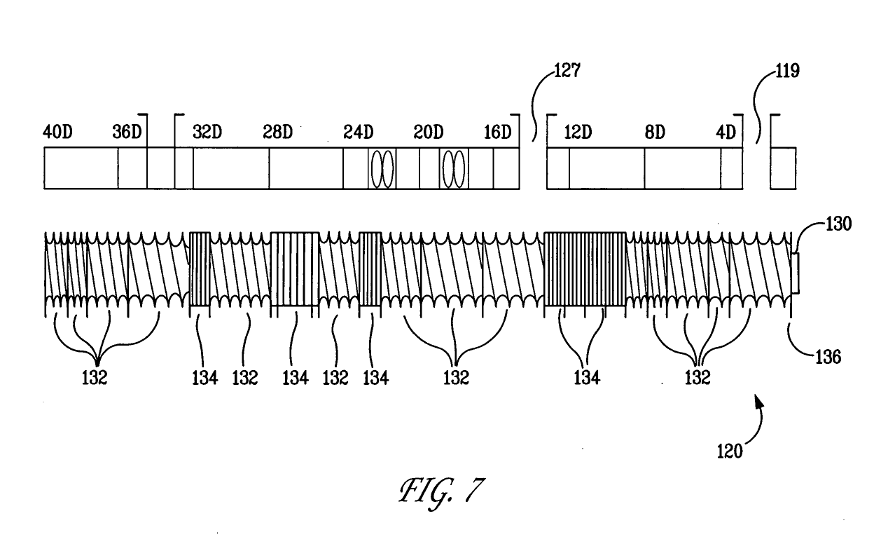

An exemplary schematic of a twin screw compounding extruder 120 screw configuration for making fiber reinforced polypropylene composites is depicted in FIG. 7. The feed throat 119 allows for the introduction of polypropylene based resin, organic fiber, and inorganic filler into a feed zone of the twin screw compounding extruder 120. The inorganic filler may be optionally fed to the extruder 120 at the downstream feed port 127. The twin screws 30 include an arrangement of interconnected screw sections, including conveying elements 132 and kneading elements 134. The kneading elements 134 function to melt the polypropylene based resin, cut the organic fiber lengthwise, and mix the polypropylene based melt, chopped organic fiber and inorganic filler to form a uniform blend. More particularly, the kneading elements function to break up the organic fiber into about ⅛ inch to about 1 inch fiber lengths. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 134 located downstream from the feed throat is also referred to as the melting zone of the twin screw compounding extruder 120. The conveying elements 132 function to convey the solid components, melt the polypropylene based resin, and convey the melt mixture of polypropylene based polymer, inorganic filler and organic fiber downstream toward the strand die 128 (see FIG. 5) at a positive pressure.

The position of each of the screw sections as expressed in the number of diameters (D) from the start 136 of the extruder screws 130 is also depicted in FIG. 7. The extruder screws in FIG. 7 have a length to diameter ratio of 40/1, and at a position 32D from the start 136 of screws 130, there is positioned a kneading element 134. The particular arrangement of kneading and conveying sections is not limited to that as depicted in FIG. 7, however one or more kneading blocks consisting of an arrangement of interconnected kneading elements 134 may be positioned in the twin screws 130 at a point downstream of where organic fiber and inorganic filler are introduced to the extruder barrel. The twin screws 130 may be of equal screw length or unequal screw length. Other types of mixing sections may also be included in the twin screws 130, including, but not limited to, Maddock mixers, and pin mixers.

Referring once again to FIG. 5, the uniformly mixed fiber reinforced polypropylene composite melt comprising polypropylene based polymer 100, inorganic filler 112, and organic fiber 114 is metered by the extruder screws to a strand die 128 for forming one or more continuous strands 140 of fiber reinforced polypropylene composite melt. The one or more continuous strands 40 are then passed into water bath 142 for cooling them below the melting point of the fiber reinforced polypropylene composite melt to form a solid fiber reinforced polypropylene composite strands 144. The water bath 142 is typically cooled and controlled to a constant temperature much below the melting point of the polypropylene based polymer. The solid fiber reinforced polypropylene composite strands 144 are then passed into a pelletizer or pelletizing unit 46 to cut them into fiber reinforced polypropylene composite resin 48 measuring from about ¼ inch to about 1 inch in length. The fiber reinforced polypropylene composite resin 148 may then be accumulated in containers 50 or alternatively conveyed to silos for storage and eventual conveyance to a thermoforming, injection molding or injection/compression molding line 200.

As may be appreciated by those skilled in the art, the majority of today's automotive paint systems employ basecoat/clearcoat systems. With conventional metallic body panels, a first primer is applied, known as the E-coat, or electro-primer, which is utilized to provide corrosion protection. This is followed by a rinsing and drying cycle, which is followed by an electrostatic paint process, achieved by negatively charging the paint particles and grounding, or positively charging the workpiece. Following this, the vehicle is caulked and sealed and sprayed with a primer. The primer serves to fill very minute scratches and imperfections in the body, and may also serve to improve the adherence of the basecoat. This primer step is then typically followed by the application of the basecoat and clearcoat.

A basecoat serves to provide the vehicle with its color and dries to a dull finish, with the clearcoat serving to provide the desired level of gloss. As may be appreciated, in an assembly line situation, vehicles must be painted, dried and moved on to the next assembly step in a relatively short period of time. To address assembly line requirements, two types of paint systems have been developed: a one component (1K) melamine-based system; and a two component (2K) polyurethane-based system. These systems are available for both basecoat and clearcoat paints and each is available in solvent-based and water-born forms.

In any type of paint system, there must be activation; that is, something that initiates the drying and curing process. With a melamine or one component material, the activation is started by a baking process. It is activated or cross-linked by the temperature and time spent at that temperature. This type of system is baked at a very high temperature, typically 265-285 degrees F., for about 20-30 minutes. In this system, the components of the resins are very stable, so that no activation or cross-linking takes place until a certain temperature is reached. Suppliers of one component systems include E. I. du Pont de Nemours and Company of Wilmington, Del., BASF Corporation of Florham Park, N.J. and others.

A polyurethane system is a two component paint that relies on a chemical reaction, accelerated by heat. The activation starts when the two components are mixed together at the sprayer, where they are precisely blended. Then the paint is atomized and sprayed on the vehicle. This system is baked at lower temps, typically 140-165 degrees F. for about 30-40 minutes. Suppliers of two component systems include E. I. du Pont de Nemours and Company of Wilmington, Del., BASF Corporation of Florham Park, N.J. and others.

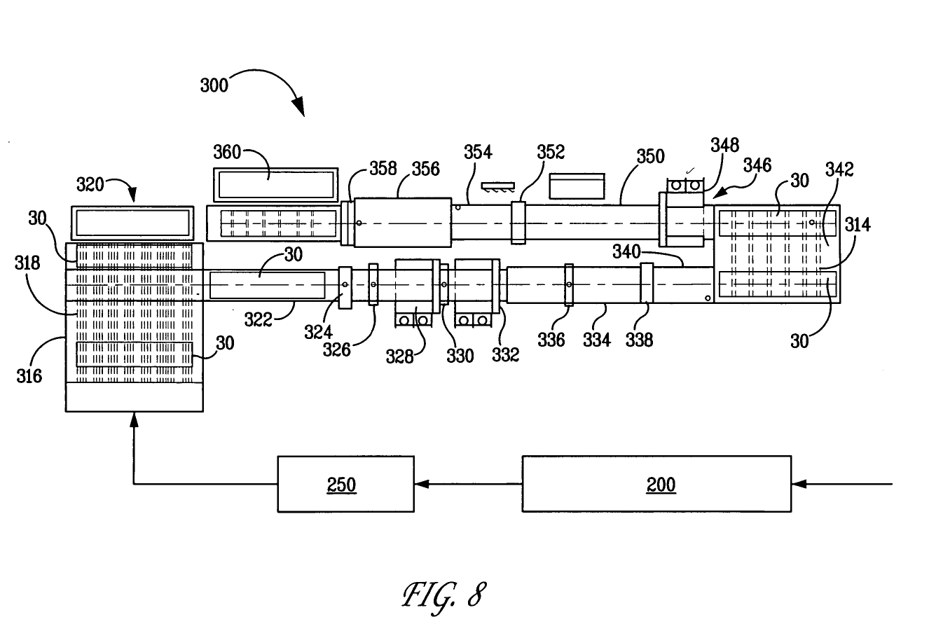

Referring now to FIG. 8, an overhead schematic view of an exemplary paint application line 300 is shown. A thermoforming, injection molding or injection/compression molding line 200 produces fiber reinforced polypropylene composite panels 30, which, once produced, are transferred to a power wash station 250 prior to arriving at paint application line 300. Depending upon line requirements, multiple power wash stations 250 may be employed. Paint line 300 comprises a transfer conveyer 316 which moves fiber reinforced polypropylene composite panels 30 from the power wash station 250 of thermoforming line 200 to the paint line 300 by rollers 318 on conveyer 316, which moves fiber reinforced polypropylene composite panel 30 perpendicularly from thermoforming line 200 to paint line 300, which is illustratively positioned parallel to thermoforming line 200. If, for example, fiber reinforced polypropylene composite panel 30 is not scheduled to receive a paint application, it can be removed from the line at an off-load point 320. If fiber reinforced polypropylene composite panel 30 is to receive a paint application, it is loaded onto paint line 300 via a staging section 322.

In accordance with the present invention, the first stage of the paint process of paint line 300 is to flame treat the top surface of fiber reinforced polypropylene composite panel 30 at flame treatment station 324. The flame treatment process is a means to relax the surface tension and to ionize the fiber reinforced polypropylene composite panel 30 for improved chemical bonding. This is believed to decrease the surface tension of the fiber reinforced polypropylene composite panel 30, the decrease in surface tension allowing the fiber reinforced polypropylene composite to have a similar surface tension to that of the paint. This has been found to create better adhesion of the paint to the fiber reinforced polypropylene composite panel 30. In the illustrative embodiment, the flame treatment station 324 may employ a blue flame of about 0.125 inches to about 0.375 inches in height. The fiber reinforced polypropylene composite panel 30 may be passed below the flame at a distance of about 0.375 inches and at a rate of about 20 to about 30 feet per minute. Of course, the size and overall geometry of the fiber reinforced polypropylene composite component may require that the setup of the flame treatment machine be altered, and that, with respect to flame size, temperature, feed rate and the distance that fiber reinforced polypropylene composite panel 30 is positioned from the flame, the parameters discussed above are merely illustrative. It may be appreciated by those skilled in the art that other means of heating the surface of fiber reinforced polypropylene composite panel 30 are contemplated herein. For example, other oxidative processes such as corona treatment or plasma treatment may advantageously be employed.

As may be appreciated, much of paint line 300 will be enclosed and, therefore, after the flame treatment stage 324, an air input section is added to create positive pressure within the line. In the illustrative embodiment, a fan is added to this section to input air which will blow dust and debris away from the fiber reinforced polypropylene composite panel 30 to keep it clean. The next stage of paint line 300 is an optional primer spray booth 328. Booth 328 applies an optional primer to the surface of fiber reinforced polypropylene composite panel 30 that may also assist in the adhesion of subsequent paint layers. In this illustrative embodiment, a down-draft spray of the primer coat is applied to the surface of fiber reinforced polypropylene composite panel 30. Exiting booth 328, another air input section 330 is illustratively located to further create positive pressure to continue preventing dust or other contaminates from resting on the surface of the panel.

After fiber reinforced polypropylene composite panel 30 exits the optional primer spray booth 328, it enters a base coat spray booth 332, wherein a base coat is applied in preparation for the final clear coat. In this illustrative embodiment, the booth 332 uses a down-draft spray to apply the base coat onto fiber reinforced polypropylene composite panel 30.

Exiting booth 328, fiber reinforced polypropylene composite panel 30 then enters an ambient flash stage 334 wherein the fiber reinforced polypropylene composite panel 30 rests to allow solvents from the paint to evaporate. Though not shown, the solvents are drawn from the ambient flash stage 334 where the solvents may be burned so as to not enter the atmosphere. In addition, stage 334 may include an input fan 336, similar to air inputs 326 and 330, to maintain positive pressure in this section.

After allowing the solvents to dissipate from the surface of the fiber reinforced polypropylene composite panel 30, it is transported under a UV cure lamp 338 to further cure the paint. The UV cure lamp 338 is illustratively a high-intensity, ultra-violet light to which the paint is sensitive, and which will further cure the paint.

After passing through UV cure lamp 338, the fiber reinforced polypropylene composite panel 30 is passed through an infrared oven 340. The fiber reinforced polypropylene composite panel 30 is moved through oven 340 at an illustrative rate of between about 2 to about 4 meters per minute and the IR oven is set at about 165 degrees F. This step further assists to drive out any remaining solvents that might not have been driven off prior to the UV cure. In addition, those solvents are also then sent off and burned before reaching the atmosphere.

Once exiting the IR oven 340, fiber reinforced polypropylene composite panel 30 is transferred to a side transfer section 342 which allows either removal of fiber reinforced polypropylene composite panel 30, if the paint applied at booth 332 was the final application of paint, or through conveyors 344 as shown in FIG. 8, if fiber reinforced polypropylene composite panel 30 is to be transferred to a final paint line 346.

If fiber reinforced polypropylene composite panel 30 is transferred to final paint line 346, it passes through clear spray booth 348. Booth 348 uses a down-draft spray to apply a clear coat and clear coat catalyst mixture. The clear coat will be the finished coat of paint applied to the fiber reinforced polypropylene composite panel 30 and provides a Class A auto finish as previously discussed. Once the clear coat has been applied onto the surface of fiber reinforced polypropylene composite panel 30, the fiber reinforced polypropylene composite panel 30 is again subjected to an ambient flash at section 350, similar to ambient flash stage 334 previously discussed, wherein the solvents are allowed to evaporate, and are driven off and burned. Furthermore, the fiber reinforced polypropylene composite panel 30 is transferred through a UV cure 352 section, similar to that of 338 and as previously discussed, the UV cure 352 serves also as UV high-intensity light to further cure the topcoat applied at 348. After passing through the UV section 352, fiber reinforced polypropylene composite panel 30 then enters infrared oven 354, which is similar to IR oven 340 previously discussed, wherein the panel is subjected to a temperature of about 165 degrees F. for about two or about three minutes.

When fiber reinforced polypropylene composite panel 30 exits the IR oven, it may enter an optional inspection booth 356 where the surface is inspected for defects in the paint. The inspection can be either manually accomplished by visual inspection of the surface and identifying such defects, or can be accomplished through an automated inspection process comprising sensors to locate defects, etc. In addition, the inspection booth 356 also serves as a cool-down station for the process. The inspection booth 356 maintains a temperature of about 70 to about 80 degrees F., with about 50 weight percent relative humidity to cool down at least the surface of the fiber reinforced polypropylene composite panel 30 from the IR oven to about 80 degrees F. If a fiber reinforced polypropylene composite panel 30 does not pass inspection, it can be removed for repair or recycling. If the fiber reinforced polypropylene composite panel 30 passes inspection, it will pass through a pinch roller 358 that will apply a slip sheet which is illustratively a thin (about 4 millimeter) polypropylene sheet that protects the painted surface of fiber reinforced polypropylene composite panel 30 and allow the same to be stacked at the off-load section 360.

In the event that there are any defects in the fiber reinforced polypropylene composite components used to manufacture automobile body components and interiors trim pieces, such components have the ability to be recycled into new materials.

The present invention is further illustrated by means of the following examples and the advantages thereto without limiting the scope thereof.

Test Methods

Fiber reinforced polypropylene composites capable of benefiting from the paint systems and methods disclosed herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., and 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc, V3837 is a high aspect ratio talc, and Jetfine 700 C is a high surface area talc, all available from Luzenac America Inc. of Englewood, Colo.

### Illustrative Examples 1-8

Varying amounts of PP3505G and 0.25″ long polyester fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | Wt % | Wt % | Total Energy | Instrumented |
|---|---|---|---|---|
| Example # | PP3505G | Fiber | (ft-lbf) | Impact Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | Brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ long polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| Example | Impact Conditions/Applied | Energy | Impact Test |
| # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | | | |
|---|---|---|---|---|
| Test | PET fiber-reinforced | | Example 16 | |
| (Method) | PP7805 with talc | | PP8224 | |
| Flexural Modulus, Chord | 525,190 | psi | 159,645 | psi |
| (ISO 178) | | | | |
| Instrumented Impact at −30° C. | 6.8 | J | 27.5 | J |
| Energy to maximum load | | | | |
| 100 lbs at 5 MPH | | | | |
| (ASTM D3763) | | | | |
| Notched Charpy Impact at | 52.4 | kJ/m² | 5.0 | kJ/m² |
| −40° C. | | | | |
| (ISO 179/1 eA) | | | | |
| Heat Deflection Temperature | 116.5° | C. | 97.6° | C. |
| at 0.45 Mpa, edgewise | | | | |
| (ISO 75) | | | | |

| | | |
|---|---|---|
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ long polyester fibers obtained from Invista Corporation, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact |
|---|---|---|---|
| | | | at −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester fibers obtained from Invista Corporation, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in examples 19-24, the samples displayed no splintering in drop weight testing at an −29° C., 15 miles per hour at 25 pounds.

### Illustrative Examples 25-26

Two materials, one containing 10% ¼ inch polyester fibers, 35% PP3505 polypropylene and 60% V3837 talc (example 25), the other containing 10% ¼ inch polyester fibers, 25% PP3505 polypropylene homopolymer (example 26), 10% PO1020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to failure | Cycles to failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 5. The screw configuration used is depicted in FIG. 7, and includes an arrangement of conveying and kneading elements. Talc, polypropylene and PET fiber were all fed into the extruder feed hopper located approximately two diameters from the beginning of the extruder screws (19 in the FIG. 7). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was injection molded and displayed the following properties:

TABLE 7

| | Example 27 | |
|---|---|---|
| Specific Gravity | 1.3 | |
| Tensile Modulus, Chord @ 23° C. | 541865 | psi |
| Tensile Modulus, Chord @ 85° C. | 257810 | psi |
| Flexural Modulus, Chord @ 23° C. | 505035 | psi |
| Flexural Modulus, Chord @ 85° C. | 228375 | psi |
| HDT @ 0.45 MPA | 116.1° | C. |
| HDT @ 1.80 MPA | 76.6° | C. |
| Instrumented impact @ 23° C. | 11.8 | J D** |
| Instrumented impact @ −30° C. | 12.9 | J D** |

**Ductile failure with radial cracks

In Example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In Example 29, the fiber was fed into a hopper placed 14 diameters down the extruder (27 in the FIG. 7). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as Examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The polypropylene composite resin produced while all temperature zones of the extruder were set to 120° C. was injection molded and displayed the following properties:

TABLE 8

| | Example 30 | |
|---|---|---|
| Flexural Modulus, Chord @ 23° C. | 467,932 | psi |
| Instrumented impact @ 23° C. | 8.0 | J D** |
| Instrumented impact @ −30° C. | 10.4 | J D** |

**Ductile failure with radial cracks

### Illustrative Examples 31-33

Three specimens of injection molded polypropylene composite resin were prepared as in Example 30 and flame treated and painted as described hereinabove. The flame treated and painted specimens exhibited the following properties:

| | | 24041-188-1 | 24041-188-1 | 24041-188-1 |
|---|---|---|---|---|
| | | Lot: N/A | Lot: N/A | Lot: N/A |
| | | White | White | White |
| | | DuPont WBBC/2K(A) | DuPont WBBC/2K(A) | DuPont WBBC/2K(A) |
| Test | Method | Specimen #1 | Specimen #2 | Specimen #3 |
| Aggressive Adhesion | 2 mm Crosshatch | 0% Removal on all specimens tested | | |
| 898 Tape | 5 Tape Pulls | | | |
| Water Resistance | FLTM BI 104-01 | | | |
| 240 hrs. at 32° ± 1° C. | Method C | | | |
| Appearance | ASTM D714 | No Blistering on all specimens tested | | |
| | Thumbnail | No Softening on all specimens tested | | |
| | SAE J1545 | Avg. ΔE = 0.352 | | |
| Δ 60° Gloss | ASTM D523 | −0.7 | −0.5 | −0.4 |
| Paint Adhesion | FLTM BI 106-01 | 0% Removal on all specimens tested | | |
| | Method D | | | |
| Scuff Resistance at 85° ± 2° C. | GM9911P | 0% Removal on all specimens tested | | |
| Stylus “C”, 100 Cycles, 1 lb. Weight | | | | |
| Water Jet at 74° Temperature | GM9531P | 1 mm² Removal | 1 mm² Removal | 0 mm² Removal |
| 1200 psi, 25° Fan Angle, 75 mm Distance | | | | |
| Chip Resistance | SAE J400 | 3A, 6B (S/P) | 2A, 7B (S/P) | Not Tested |
| 2 Pints, 45° Angle, 25° ± 5° C. | Method C | | | |
| Chip Resistance | SAE J400 | 5A, 7B (S/P) | 5A, 8B (S/P) | Not Tested |
| 2 Pints, 45° Angle, 0° F. | Method B | | | |
| Humidity, 96 hrs. | GM4465P | | | |
| Appearance | ASTM D714 | No Blistering on all specimens tested | | |
| | SAE J1545 | Avg. ΔE = 0.772 | | |
| Δ 60° Gloss | ASTM D523 | −0.1 | 0.1 | 0.6 |
| Tape Adhesion, Cross Hatch | GM9071P | 100% Retention on all specimens tested | | |
| | Method A | | | |
| Tape Adhesion, Cross Cut | GM9071P | 100% Retention on all specimens tested | | |
| | Method B | | | |
| Fuel Resistance | Modified | | | |
| CE-10 Test Fuel | Juntunen's | | | |
| 15 min. | % Removal | 0 | 0 | 0 |
| | % Blistering | 0 | 0 | 0 |
| | % Intact | 100 | 100 | 100 |
| 30 min. | % Removal | 0 | 0 | 0 |
| | % Blistering | 0 | 0 | 0 |
| | % Intact | 100 | 100 | 100 |
| 45 min. | % Removal | 0 | 0 | 0 |
| | % Blistering | 0 | 0 | 0 |
| | % Intact | 100 | 100 | 100 |
| 60 min. | % Removal | 0 | 0 | 0 |
| | % Blistering | 0 | 0 | 0 |
| | % Intact | 100 | 100 | 100 |

As may be seen, each of the three specimens of injection molded polypropylene composite resin exhibited prepared in accordance with the present invention exhibited excellent adhesion characteristics without the use of a solvent-based adhesion promoter.

### Illustrative Examples 34-36

Three specimens of injection molded polypropylene composite resin were prepared as in Example 30, but, rather than receiving a flame treatment, a solvent-based adhesion promoter was applied prior to painting. The specimens so prepared exhibited the following properties:

| | | 24041-188-1 | 24041-188-1 | 24041-188-1 |
|---|---|---|---|---|
| | | Lot: N/A | Lot: N/A | Lot: N/A |
| | | White | White | White |
| | | DuPont 1K/2K (B) | DuPont 1K/2K (B) | DuPont 1K/2K (B) |
| Test | Method | Specimen #1 | Specimen #2 | Specimen #3 |
| Aggressive Adhesion | 2 mm Crosshatch | Pull 1 = 0% Removal | Pull 1 = 0% Removal | 0% Removal |
| 898 Tape | 5 Tape Pulls | Pull 2 = 1% Removal | Pull 2 = 0% Removal | |
| | | Pull 3 = 2% Removal | Pull 3 = 0% Removal | |
| | | Pull 4 = 0% Removal | Pull 4 = 4% Removal | |
| | | Pull 5 = 0% Removal | Pull 5 = 4% Removal | |
| | | Removal outside of | Removal outside of | |
| | | grid on Pulls 3, 4, & 5 | grid on Pulls 1, 4, & 5 | |
| Water Resistance | FLTM BI 104-01 | | | |
| 240 hrs. at 32° ± 1° C. | Method C | | | |
| Appearance | ASTM D714 | No Blistering on all specimens tested | | |
| | Thumbnail | No Softening on all specimens tested | | |
| | SAE J1545 | Avg. ΔE = 0.521 | | |
| Δ 60° Gloss | ASTM D523 | −1.2 | −0.4 | −0.5 |
| Paint Adhesion | FLTM BI 106-01 | 0% Removal on all specimens tested | | |
| | Method D | | | |
| Scuff Resistance at 85° ± 2° C. | GM9911P | 61.1% Removal | 97.2% Removal | 25.0% Removal |
| Stylus “C”, 100 Cycles, 1 lb. Weight | | | | |
| Water Jet at 74° Temperature | GM9531P | 1 mm² Removal | 18 mm² Removal | 2 mm² Removal |
| 1200 psi, 25° Fan Angle, 75 mm Distance | | | | |
| Chip Resistance | SAE J400 | 3A, 5B (S/P) | 4A, 5B (S/P) | Not Tested |
| 2 Pints, 45° Angle, 25° ± 5° C. | Method C | | | |
| Chip Resistance | SAE J400 | 5A, 6B (S/P) | 5A, 6B (S/P) | Not Tested |
| 2 Pints, 45° Angle, 0° F. | Method B | Paint Removal at | | |
| | | bottom of plaque | | |
| | | from tape | | |
| Humidity, 96 hrs. | GM4465P | | | |
| Appearance | ASTM D714 | No Blistering on all specimens tested | | |
| | SAE J1545 | Avg. ΔE = 0.403 | | |
| Δ 60° Gloss | ASTM D523 | 0.1 | −0.3 | −0.5 |
| Tape Adhesion, Cross Hatch | GM9071P | 100% Retention | 96% Retention | 100% Retention |
| | Method A | Paint Removal | Paint Removal | |
| | | outside of 2 mm grid | outside of 2 mm grid | |
| Tape Adhesion, Cross Cut | GM9071P | 100% Retention on all specimens tested | | |
| | Method B | | | |
| Fuel Resistance | Modified | | | |
| CE-10 Test Fuel | Juntunen's | | | |
| 15 min. | % Removal | 10 | 21 | 11 |
| | % Blistering | 90 | 79 | 89 |
| | % Intact | 0 | 0 | 0 |
| 30 min. | % Removal | 35 | 45 | 30 |
| | % Blistering | 65 | 55 | 70 |
| | % Intact | 0 | 0 | 0 |
| 45 min. | % Removal | 65 | 85 | 45 |
| | % Blistering | 35 | 15 | 55 |
| | % Intact | 0 | 0 | 0 |
| 60 min. | % Removal | 67 | 89 | 62 |
| | % Blistering | 33 | 11 | 38 |
| | % Intact | 0 | 0 | 0 |

As may be seen, the three specimens of injection molded polypropylene composite resin utilizing a solvent-based adhesion promoter, rather than flame treatment, exhibited much poorer adhesion characteristics when compared with the results obtained for the specimens of Examples 31-33.

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

When numerical lower limits and numerical upper limits are listed herein, ranges from any lower limit to any upper limit are contemplated.

What is claimed is:

1. A method of painting a fiber reinforced composite vehicle component, the fiber reinforced composite vehicle component molded from a composition comprising a polypropylene based resin, an organic fiber and an inorganic filler, the component having at least a first surface, comprising the steps of:
(a) lowering the surface tension of the first surface of the fiber reinforced composite vehicle component;
(b) applying a base coat paint to the first surface of the fiber reinforced composite vehicle component; and
(c) applying a clear coat paint to the first surface of the fiber reinforced composite vehicle component.

2. The method of claim 1, wherein said surface tension lowering step is selected from the group consisting of flame treating, corona discharge treating and plasma treating.

3. The method of claim 2, wherein said surface tension lowering step is a flame treating step.

4. The method of claim 3, wherein said flame treating step employs a blue flame.

5. The method of claim 3, wherein the blue flame of said flame treating step has a height of about 0.125 inches to about 0.375 inches.

6. The method of claim 3, wherein the fiber reinforced composite vehicle component is positioned at a distance of about 0.375 inches from the blue flame of said flame treating step.

7. The method of claim 3, wherein the fiber reinforced composite vehicle component is passed below the flame of said flame treating step at a rate of about 20 to about 30 feet per minute.

8. The method of claim 1, wherein in step (b) the base coat paint is selected from the group consisting of a one component (1K) melamine-based system and a two component (2K) polyurethane-based system.

9. The method of claim 1, wherein in step (c) the clear coat paint is selected from the group consisting of a one component (1K) melamine-based system and a two component (2K) polyurethane-based system.

10. The method of claim 9, wherein in step (c) the clear coat paint is a two component (2K) polyurethane-based system.

11. The method of claim 1, further comprising the step of power washing the fiber reinforced composite vehicle component prior to conducting said surface tension lowering step.

12. The method of claim 1, wherein the fiber reinforced composite vehicle component is molded from a composition comprising at least 30 wt % polypropylene based resin, from 10 to 60 wt % organic fiber, and from 0 to 40 wt % inorganic filler, based on the total weight of the composition.

13. The method of claim 1, wherein the polypropylene based resin is selected from the group consisting of polypropylene homopolymers, propylene-ethylene random copolymers, propylene-α-olefin random copolymers, propylene impact copolymers, and combinations thereof.

14. The method of claim 1, wherein the organic fiber is selected from the group consisting of polyalkylene terephthalates, polyalkylene naphthalates, polyamides, polyolefins, polyacrylonitrile, and combinations thereof.

15. The method of claim 1, wherein the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

16. The method of claim 15, wherein the inorganic filler is talc or wollastonite.

17. The method of claim 1, wherein the fiber reinforced composite vehicle component is a vehicle body panel.

18. The method of claim 17, wherein the vehicle body panel is selected from the group consisting of a hood, a roof, a deck lid, a door, a front or rear fender, a rocker panel, a fascia, a fender liner, a firewall, a truck bed, a tailgate, a radiator support, an airdam, a rollpan, a support bracket, a cowl screen, a lift gate, a step assist, a running board, a rub strip, cladding and a front or rear quarter panel.

19. The method of claim 1, wherein at least the first surface of the fiber reinforced composite vehicle component is provided with a class A surface finish.

20. The method of claim 1, wherein the painted fiber reinforced composite vehicle component exhibits excellent adhesion characteristics in the absence of a solvent-based adhesion promoter.

21. The method of claim 1, further comprising the step of applying a water-born or solvent-based primer coat to the first surface of the fiber reinforced composite vehicle component prior to step (b).

22. A paint system for use in painting a fiber reinforced composite vehicle component molded from a composition comprising a polypropylene based resin, an organic fiber and an inorganic filler, the component having at least a first surface of reduced surface tension, comprising:
(a) a base coat paint for applying to the first surface of the fiber reinforced composite vehicle component; and
(b) a clear coat paint for applying over said base coat;
wherein said paint system exhibits excellent adhesion characteristics.

23. The paint system of claim 22, wherein the surface tension of the first surface is reduced by flame treating, corona discharge treating or plasma treating.

24. The paint system of claim 23, wherein the surface tension of the first surface is reduced by flame treating.

25. The paint system of claim 24, wherein the first surface of the fiber reinforced composite vehicle component is flame treated with a blue flame.

26. The paint system of claim 24, wherein the blue flame has a height of about 0.125 inches to about 0.375 inches.

27. The paint system of claim 24, wherein the fiber reinforced composite vehicle component is positioned at a distance of about 0.375 inches from the blue flame to achieve the flame treated first surface.

28. The paint system of claim 24, wherein the fiber reinforced composite vehicle component is passed below the flame at a rate of about 20 to about 30 feet per minute flame to achieve the flame treated first surface.

29. The paint system of claim 22, wherein said base coat paint is selected from the group consisting of a one component (1K) melamine-based system and a two component (2K) polyurethane-based system.

30. The paint system of claim 22, wherein said clear coat paint is selected from the group consisting of a one component (1K) melamine-based system and a two component (2K) polyurethane-based system.

31. The paint system of claim 30, wherein said clear coat paint is a two component (2K) polyurethane-based system.

32. The paint system of claim 22, wherein the first surface of the fiber reinforced composite vehicle component is power washed prior to flame treating.

33. The paint system of claim 22, wherein the fiber reinforced composite vehicle component is molded from a composition comprising at least 30 wt % polypropylene based resin, from 10 to 60 wt % organic fiber, and from 0 to 40 wt % inorganic filler, based on the total weight of the composition.

34. The paint system of claim 22, wherein the polypropylene based resin is selected from the group consisting of polypropylene homopolymers, propylene-ethylene random copolymers, propylene-α-olefin random copolymers, propylene impact copolymers, and combinations thereof.

35. The paint system of claim 22, wherein the organic fiber is selected from the group consisting of polyalkylene terephthalates, polyalkylene naphthalates, polyamides, polyolefins, polyacrylonitrile, and combinations thereof.

36. The paint system of claim 22, wherein the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

37. The paint system of claim 22, wherein the fiber reinforced composite vehicle component is a vehicle body panel.

38. The paint system of claim 37, wherein the vehicle body panel is selected from the group consisting of a hood, a roof, a deck lid, a door, a front or rear fender, a rocker panel, a fascia, a fender liner, a firewall, a truck bed, a tailgate, a radiator support, an airdam, a rollpan, a support bracket, a cowl screen, a lift gate, a step assist, a running board, a rub strips, cladding and a front or rear quarter panel.

39. The paint system of claim 22, wherein at least the first surface of the fiber reinforced composite vehicle component is provided with a class A surface finish.

40. A process for producing a painted fiber reinforced polypropylene composite vehicle component, comprising the following steps:
(a) feeding into a twin screw extruder hopper at least about 25 wt % of a polypropylene based resin with a melt flow rate of from about 20 to about 1500 g/10 minutes;
(b) continuously feeding by unwinding from one or more spools into the twin screw extruder hopper from about 5 wt % to about 40 wt % of an organic fiber;
(c) feeding into a twin screw extruder from about 10 wt % to about 60 wt % of an inorganic filler;
(d) extruding the polypropylene based resin, the organic fiber, and the inorganic filler through the twin screw extruder to form a fiber reinforced polypropylene composite melt;
(e) cooling the fiber reinforced polypropylene composite melt to form a solid fiber reinforced polypropylene composite;
(f) molding the fiber reinforced polypropylene composite to form the vehicle component, the vehicle component having at least a first surface;
(g) lowering the surface tension of the first surface of the fiber reinforced composite vehicle component;
(h) applying a base coat paint to the first surface of the fiber reinforced composite vehicle component; and
(i) applying a clear coat paint to the first surface of the fiber reinforced composite vehicle component.

41. The process of claim 40, wherein said surface tension lowering step is selected from the group consisting of flame treating, corona discharge treating and plasma treating.

42. The process of claim 41, wherein said surface tension lowering step is a flame treating step.

43. The process of claim 42, wherein said flame treating step employs a blue flame.

44. The process of claim 43, wherein the blue flame of said flame treating step has a height of about 0.125 inches to about 0.375 inches.

45. The process of claim 43, wherein the fiber reinforced composite vehicle component is positioned at a distance of about 0.375 inches from the blue flame of said flame treating step.

46. The process of claim 42, wherein the fiber reinforced composite vehicle component is passed below the flame of said flame treating step at a rate of about 20 to about 30 feet per minute.

47. The process of claim 40, wherein in step (h) the base coat paint is selected from the group consisting of a one component (1K) melamine-based system and a two component (2K) polyurethane-based system.

48. The process of claim 40, wherein in step (i) the clear coat paint is selected from the group consisting of a one component (1K) melamine-based system and a two component (2K) polyurethane-based system.

49. The process of claim 48, wherein in step (i) the clear coat paint is a two component (2K) polyurethane-based system.

50. The process of claim 40, further comprising the step of power washing the fiber reinforced composite vehicle component prior to conducting said flame treating step.

51. The process of claim 40, wherein the polypropylene based resin is selected from the group consisting of polypropylene homopolymers, propylene-ethylene random copolymers, propylene-α-olefin random copolymers, propylene impact copolymers, and combinations thereof.

52. The process of claim 40, wherein the organic fiber is selected from the group consisting of polyalkylene terephthalates, polyalkylene naphthalates, polyamides, polyolefins, polyacrylonitrile, and combinations thereof.

53. The process of claim 52, wherein the organic fiber is polyethylene terephthalate.

54. The process of claim 40, wherein the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

55. The process of claim 40, further comprising the step of applying a water-born or solvent-based primer coat to the first surface of the fiber reinforced composite vehicle component prior to step (h).
